(19) United States
(12) Patent Application Publication
(10) Pub. No.: US 2018/0182123 A1
(43) Pub. Date: Jun. 28, 2018

(54) Method of selecting an article for covering a body part by processing the image of the body part

(71) Applicant: Chien Min Fang, Taichung (TW)

(72) Inventor: Chien Min Fang, Taichung (TW)

(21) Appl. No.: 15/904,424

(22) Filed: Feb. 26, 2018

(51) Int. Cl. G06T 7/62; G06T 5/00; G06T 5/50; G06K 9/62

(52) U.S. Cl. CPC G06T 7/62; G06K 9/6223; G06T 5/50; G06T 5/002

(57) ABSTRACT

A method of measuring the distance of two points of an object by processing the image of the object taken from the mobile phone. The image taken by the mobile phone should contain the object and a piece of a rectangular paper marked with a point on each corner. For example, the object (e.g., a human foot) stands on a piece of the rectangular paper which has a mark on each corner. The image taken by a mobile phone should contain the foot and at least three of the four marks. Likewise, a human standing against the wall aside with the marked paper and a hand pressing on the marked paper are all applicable to the method of measuring any two points in the image of the. The resulted distance of any two points can be used to obtain a correct size of foot or the like.

### BACKGROUND OF THE INVENTION

The invention relates to image processing and more particularly to a method of measuring size of an object (e.g., human foot) by processing the image of the human foot standing on a rectangle having a mark on each corner in which at least three marks are shown in the image.

### Description of Related Art

Conventionally, an internet online buyer may view an e-catalog having products each having a size with a corresponding measurement of length, height or width, depending on the necessity of the product vendor. Regarding shoes, a buyer may measure his (or her) foot and select a corresponding size from the e-catalog provided by the seller when making the online orders. However, in often times, the buyer has to spend a lot of time and effort in the measurement. Also, the size changes at different ages. It is difficult of saving the history of the sizes. In addition, the ordered items, for examples, shoes, are not correct after the buyer receives the goods because of visual error. This bothers both the seller and the buyer.

Thus, it is desirable to provide a method of correctly and quickly measuring the distance of any two points by processing the electronic image of the body part to select the size of shoes, hats, clothes, pantaloons and so on by matching the database provided by the seller. The image can be saved and used for any product which has classification for size.

### SUMMARY OF THE INVENTION

It is therefore one object of the invention to provide a method of selecting an article for covering a body part comprising the steps of (1) using a mobile phone to take a picture of an object rested on a rectangular paper having four marks on four corners respectively to obtain an image of the object; (2) decreasing the size of the image and smoothing the image; (3) comparing the image with a predetermined value to filter out noise; (4) further comparing the image with an adaptive threshold to filter out noise; (5) using canny edge detection to make an edge of the image clearer; (6) calculating the number of contours of the mark wherein the number of the contours of the mark is six; (7) calculating the number of the marks in the image; (8) looping back to step (1) if the number of the marks is less than three; (9) labeling the three marks shown in the image as first, second, and third marks having a coordinate; (10) obtaining a fourth mark by applying extrapolation; (11) obtaining a location of the object in the three-dimensional space; (12) executing perspective transformation on the object to obtain a distance between any two points of the object in the image; (13) subjecting the image to Lab color space transformation; (14) resizing the image; (15) converting two-dimensional characteristics of the image into one-dimensional characteristic thereof; (16) running k-means clustering (k=3) to obtain cluster centers wherein color is classified as a first cluster of skin color, a second cluster of white, and a third cluster of background; (17) applying 1-nearest neighbor classifier on the cluster centers to classify new data into the clusters, and employing Asian color index (L:90, a:12, b:12) to obtain the number of the clusters; (18) binarizing the skin color of the image for converting the pixel image into a binary image wherein a distance between each pixel of the image and the nearest cluster center is defined as 255 and a distance between the same and the distal cluster center is defined as 0; (19) measuring length of the object and width thereof respectively; (20) executing perspective transformation on the object in the image; (21) obtaining a correct size of the object; (22) inputting the correct size of the object into a shoes database stored with a plurality of different sizes and types of shoes; and (23) searching the shoes database to find a numbered shoe adapted to fit in with the object.

The above and other objects, features and advantages of the invention will become apparent from the following detailed description taken with the accompanying drawings.

### BRIEF DESCRIPTION OF THE DRAWINGS

FIG. 1 schematically depicts the foot standing on a rectangular paper having a mark on each corner according to a first preferred embodiment of the invention;

FIG. 2 is a flow chart of a method of selecting a shoe by processing the image of the foot according to the first preferred embodiment of the invention;

FIG. 3 schematically depicts six contours of the mark;

FIG. 4 schematically depicts how to find the fourth mark on the rectangular paper;

FIG. 5 shows the length of the foot in the image;

FIG. 6 shows the width of the foot in the image;

FIG. 7 schematically depicts the foot standing on a rectangular paper having three marks on three corners respectively and a fourth mark on a post rested on the paper and adjacent to the toes of the foot according to a second preferred embodiment of the invention;

FIG. 8 is a flow chart of a method of selecting a shoe by processing the image of the foot according to the second preferred embodiment of the invention; and

FIG. 9 schematically depicts a person standing in front of a wall having a rectangular paper adhered thereon, the paper having a mark on each corner according to a third preferred embodiment of the invention.

### DETAILED DESCRIPTION OF THE INVENTION

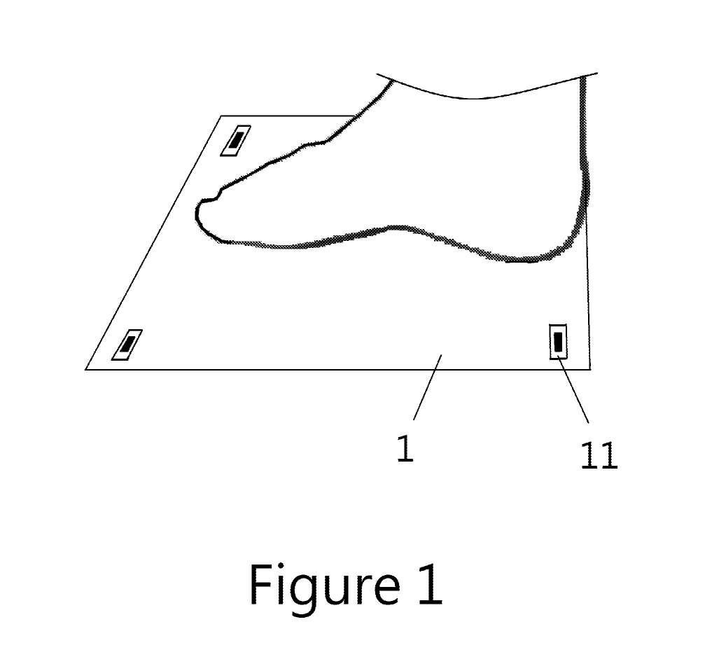

Referring to FIG. 1, it shows an object (e.g., the foot) standing on a rectangular paper 1 having a mark 11 on each corner according to a first preferred embodiment of the invention.

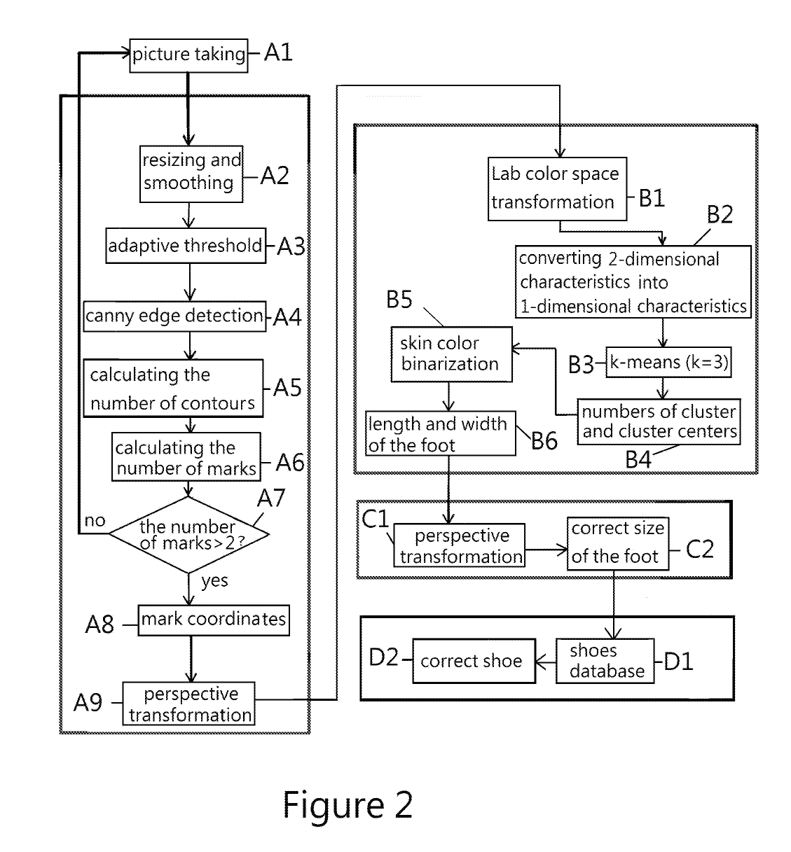

Referring to FIGS. 2 to 6 in conjunction with FIG. 1, a method of measuring the distance of any two points of a selected article (e.g., shoe) by processing the image taken from the mobile phone according to a first preferred embodiment of the invention is illustrated. The method comprises the following steps:

(A1) using a mobile phone to take a picture of the foot of FIG. 1 to obtain an image of the foot in which the foot is required to dispose on the same plane as the marks 11;

(A2) decreasing the size of the image and smoothing the image;

(A3) comparing the image with a predetermined value to filter out noise and further comparing the image with an adaptive threshold to filter out noise in order to obtain a clearer image;

(A4) using canny edge detection to make an edge of the image clearer;

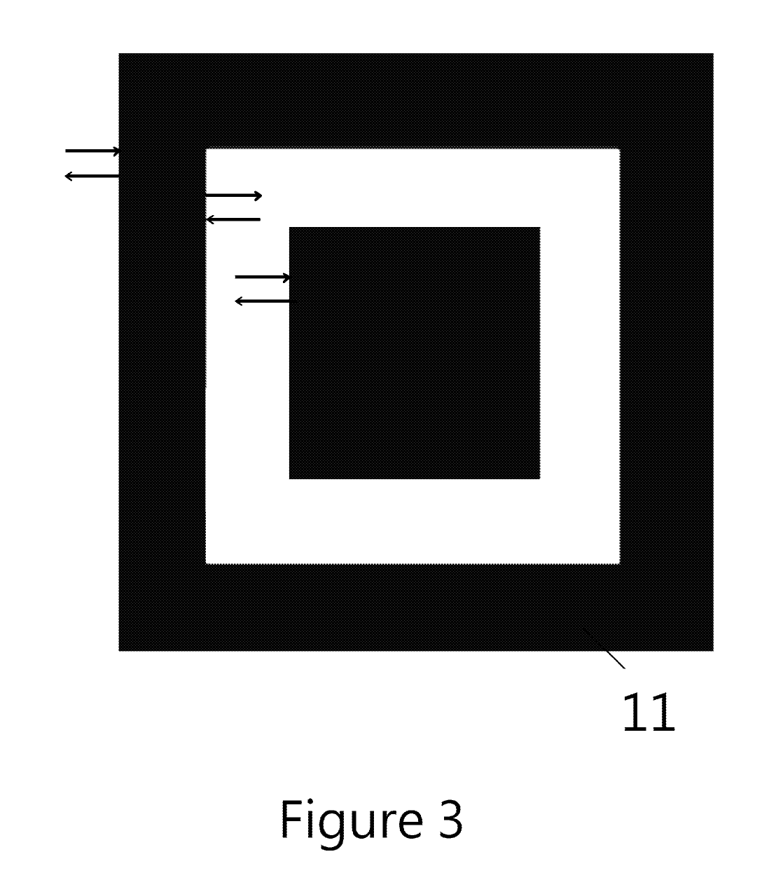

(A5) calculating the number of the contours of the mark 11 in which the number of the contours is six because there are six arrows in FIG. 3;

(A6) calculating the number of the marks 11 in the image;

(A7) the flow chart going to a next step if the number of the marks 11 is three, otherwise the flow chart looping back to step (A1);

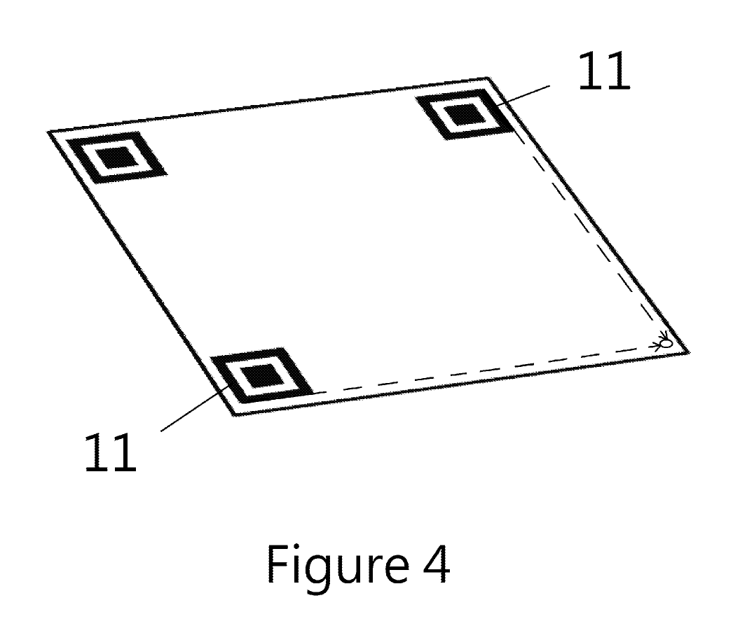

(A8) as shown in FIG. 4 the top left mark 11 defined as a first mark having a first coordinate, the top left mark 11 defined as a second mark having a second coordinate, and the top right mark 11 defined as a third mark having a third coordinate so that a fourth mark having a fourth coordinate at the bottom right corner can be obtained by applying extrapolation;

(A9) obtaining location of the image in the three-dimensional space and executing perspective transformation to obtain a distance between any two points of the image;

(B1) subjecting the image to Lab color space transformation this is because RGB color space is low in identifying the skin color so that the skin color can be enhanced by using Lab color space;

(B2) resizing the image and converting two-dimensional characteristics of the image into one-dimensional characteristic thereof;

(B3) running k-means clustering (k=3) to obtain cluster centers specifically, color is classified as a first cluster of skin color, a second cluster of white, and a third cluster of background; and the number of the contours of the mark 11 is six;

(B4) obtaining the number of clusters and the cluster centers specifically, the 1-nearest neighbor classifier on the cluster centers obtained by k-means is applied to classify new data into the existing clusters, and Asian color index (L:90, a:12, b:12) is employed to obtain the number of clusters and the cluster centers;

(B5) binarizing the skin color of the image for converting a pixel image into a binary image, specifically, a distance between each pixel of the image and the nearest cluster center defined as 255 and a distance between the same and the distal cluster center defined as 0;

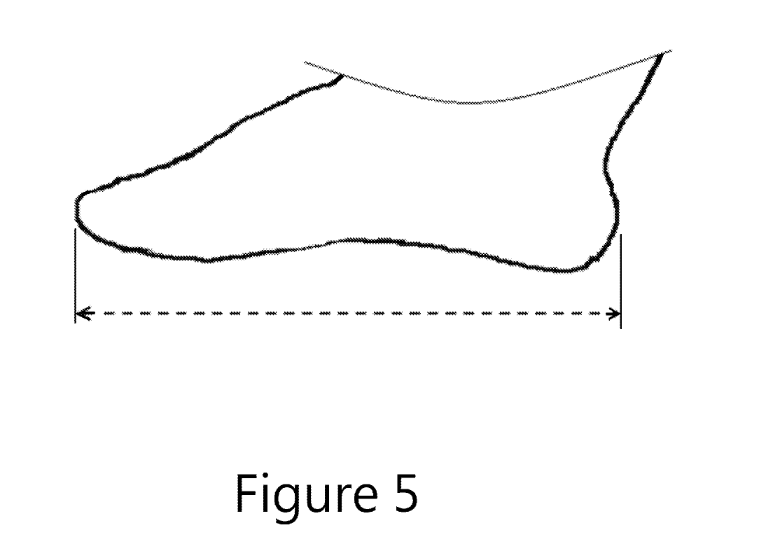

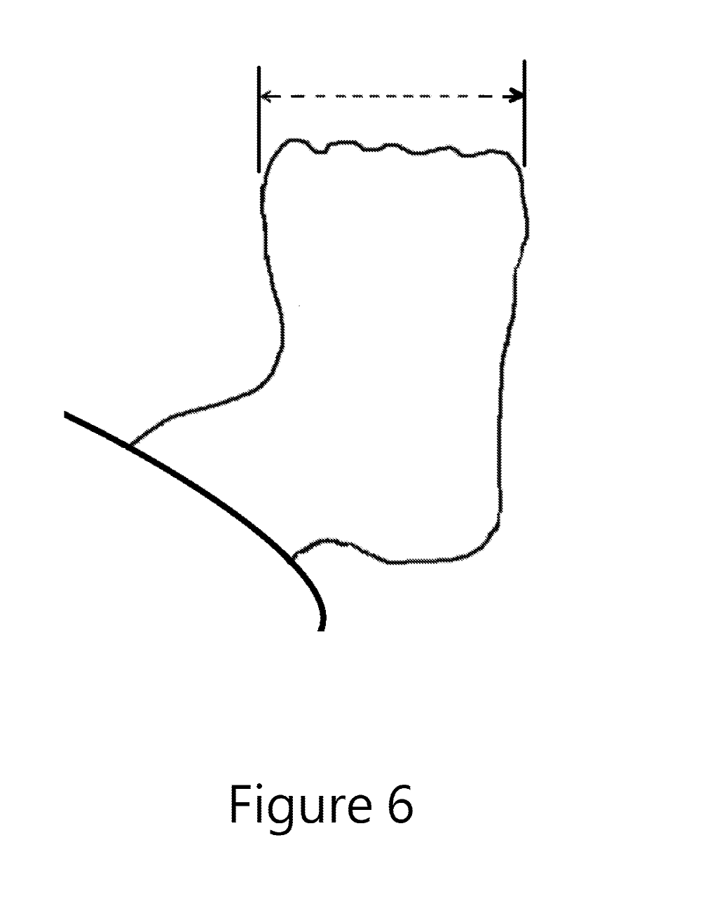

(B6) measuring the length of the foot (FIG. 5) and the width thereof (FIG. 6) respectively;

(C1) executing perspective transformation on the foot in the image;

(C2) obtaining the correct size of the foot;

(D1) inputting the size of the foot into a shoes database stored with a plurality of different sizes and types of shoes; and

(D2) searching the shoes database to find a numbered shoe adapted to fit in with the foot.

It is envisaged by the invention that a manufacturer can produce a shoe adapted to fit in with the foot in compliance with the numbered shoe.

It is understood that the method of the invention can be applied to other personal articles such as clothes without departing from the scope of the invention.

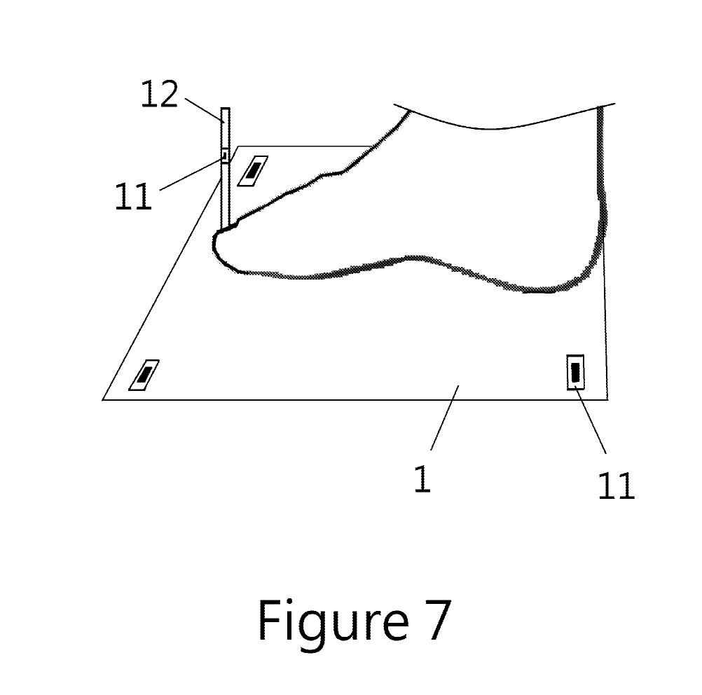

Referring to FIG. 7, it shows the foot standing on a rectangular paper 1 having three marks 11 on three corners respectively and a fourth mark 11 on a post 12 rested on the paper 1 and adjacent to the toes of the foot according to a second preferred embodiment of the invention.

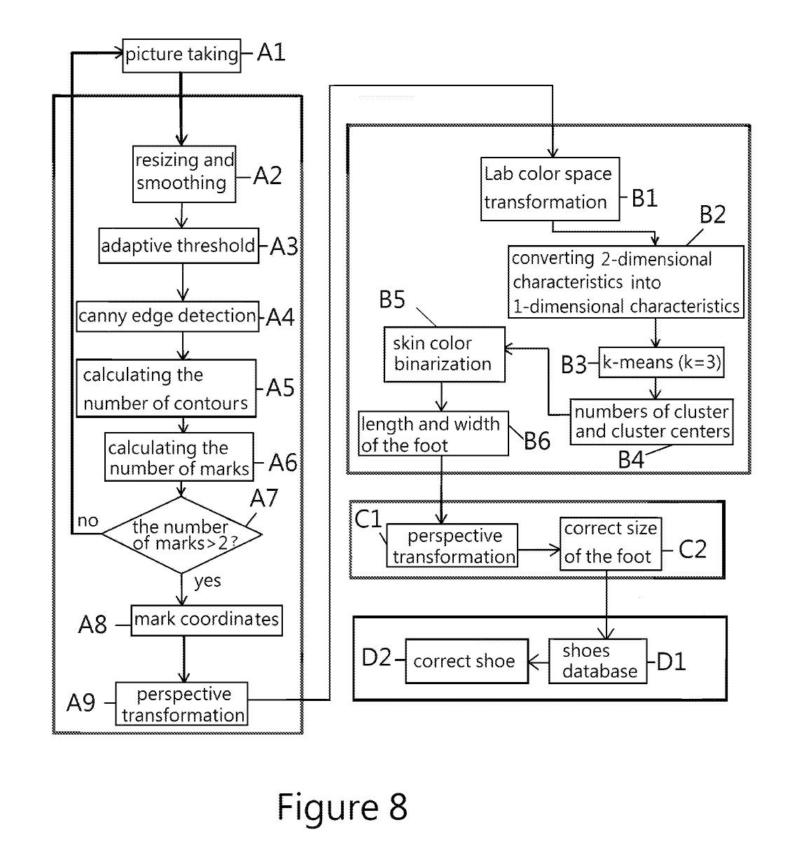

Referring to FIG. 8, it is a flow chart of a method of selecting a shoe by processing the image of the foot according to the second preferred embodiment of the invention. The steps of the method are the same as that described in FIG. 2. Thus, a detailed description thereof is omitted herein for the sake of brevity.

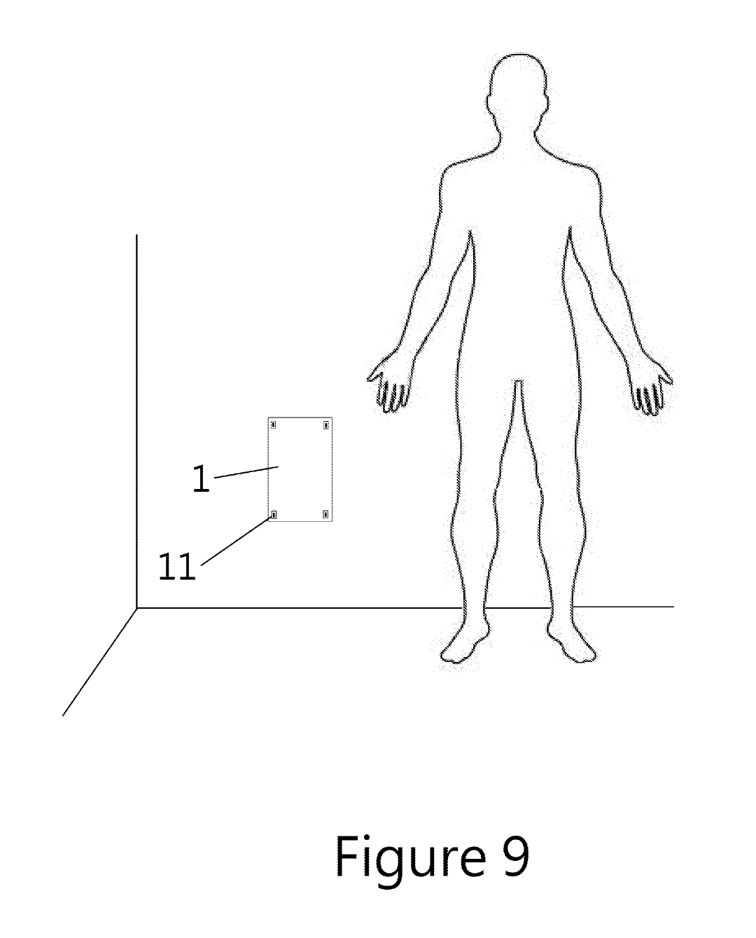

Referring to FIG. 9, it shows a person standing in front of a wall having a rectangular paper 1 adhered thereon, the paper 1 having a mark 11 on each corner according to a third preferred embodiment of the invention.

The invention has the advantages of quickly and correctly measuring a distance between any two points in an image taken by a mobile phone, obtaining a correct size of an article for covering the body part, and the measurement results can be automatically stored.

While the invention has been described in terms of preferred embodiments, those skilled in the art will recognize that the invention can be practiced with modifications within the spirit and scope of the appended claims.

1. A method of measuring size of an object comprising the steps of:
(1) using a mobile phone to take a picture of an object rested on a rectangular paper having four marks on four corners respectively to obtain an image of the object;
(2) decreasing the size of the image and smoothing the image;
(3) comparing the image with a predetermined value to filter out noise;
(4) further comparing the image with an adaptive threshold to filter out noise;
(5) using canny edge detection to make an edge of the image clearer;
(6) calculating the number of contours of the mark wherein the number of the contours of the mark is six;
(7) calculating the number of the marks in the image;
(8) looping back to step (1) if the number of the marks is less than three;
(9) labeling the three marks shown in the image as first, second, and third marks having a coordinate;
(10) obtaining a fourth mark by applying extrapolation;
(11) obtaining a location of the object in the three-dimensional space;
(12) executing perspective transformation on the object to obtain a distance between any two points of the object in the image;
(13) subjecting the image to Lab color space transformation;
(14) resizing the image;
(15) converting two-dimensional characteristics of the image into one-dimensional characteristic thereof;
(16) running k-means clustering (k=3) to obtain cluster centers wherein color is classified as a first cluster of skin color, a second cluster of white, and a third cluster of background;
(17) applying 1-nearest neighbor classifier on the cluster centers to classify new data into the clusters, and employing Asian color index (L:90, a:12, b:12) to obtain the number of the clusters;
(18) binarizing the skin color of the image for converting the pixel image into a binary image wherein a distance between each pixel of the image and the nearest cluster center is defined as 255 and a distance between the same and the distal cluster center is defined as 0;
(19) measuring length of the object and width thereof respectively;
(20) executing perspective transformation on the object in the image; and
(21) obtaining a correct size of the object.

2. The method of claim 1, further comprising a post having a fifth mark disposed thereon.
